(19) United States
(12) Patent Application Publication
(10) Pub. No.: US 2004/0099080 A1
(43) Pub. Date: May 27, 2004

(54) Magnetic speed controlling twist grip assembly

(76) Inventor: Pei-Hsuan Hsu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/300,367

(22) Filed: Nov. 21, 2002

(51) Int. Cl. F02D 9/06

(52) U.S. Cl. 74/489; 477/209

(57) ABSTRACT

A magnetic speed controlling twist grip assembly includes a linear IC, first and second magnets, a stationary member; and a rotary handle turnably connected to the stationary member at an inward end. The linear IC is disposed in the stationary member. The first and second magnets are disposed at the inward end of the handle such that different magnetic poles thereof face respective ones of opposite sides of the linear IC. The magnetic field around the linear IC is changed when position of the magnets relative to the linear IC is adjusted with the user's hand turning the rotary handle, and in turn, electric currents passing through the linear IC is changed. A control device, to which the linear IC is electrically connected, will control electric power supplied from a storage battery to a motor accordingly, thus controlling speed of the motor.

### BACKGROUND OF THE INVENTION

1. Field of the invention

The present invention relates to a magnetic speed-controlling handle, more particularly a magnetic speed-controlling handle, which is provided for use on an electric motorbike or an electric cart for the handicapped, and which are equipped with lamps thereon for indicating conditions of the battery and various parts thereof.

2. Brief Description of the Prior Art

Twist grip throttles are provided on conventional fuel motorcycles for the riders to hold and turn with their hands. Twist grip throttles are turned for controlling the flow of fuel to be supplied to the cylinders of fuel motorcycles in order to control the speed of the pistons of the cylinders, thus controlling the speed of motorcycles.

Similarly, twist grips are fitted to electric motorbikes or other electric vehicles for controlling electric power to be supplied to the motors of electric vehicles with riders' hands in order to increase or decrease the speed of vehicles. One conventional twist grip of electric motorbikes or other electric vehicles usually includes a contact element, and a stationary variable resistor, which is usually made into a curved plate. The contact element is in contact with the stationary variable resistor so that resistance of the variable resistor can be changed by means of turning the twist grip to change the position of the contact element on the resistor. Thus, electric current supplied to the motor of a vehicle is controlled for changing the speed of the vehicle. However, such twist grip of electric vehicles have a disadvantage that both the resistor and the contact element are subject to wear due to friction against each other in operation of the twist grip. Therefore, the electric contact between the parts is prone to become loose, and in turn, the speed of electric vehicles with the twist grip cannot be controlled properly. In other words, this type of twist grip has relatively short service life.

### SUMMARY OF THE INVENTION

It is a main object of the present invention to provide a speed controlling twist grip assembly of an electric vehicle, which is not subject to wear.

It is another object of the present invention to provide a speed controlling twist grip assembly of an electric vehicle, which has lamps fitted thereon for indicating various conditions of the storage battery and a fault of the circuit thereof.

The speed controlling twist grip assembly includes a linear IC, first and second magnets, a stationary member, and a rotary handle, which is turnably connected to the stationary member at an inward end. The linear IC is disposed in the stationary member. The first and second magnets are disposed at the inward end of the handle such that different magnetic poles thereof face respective ones of two opposite sides of the linear IC. A control device is electrically connected to the linear IC, a storage battery, and a motor. When a user turns the rotary handle with his hands to adjust the position of the magnets relative to the linear IC, the magnetic field around the linear IC is changed, and in turn, electric currents passing through the linear IC is changed. Thus, the control device can control electric power supplied from the storage battery to the motor accordingly, thus controlling speed of the motor.

Lamps are provided for indicating various conditions of the storage battery, e.g. power-insufficient, half-full, and full conditions, when emitting light continuously, and one of the lamps is provided to indicate a fault in the circuit with intermittent light.

### BRIEF DESCRIPTION OF THE DRAWINGS

The present invention will be better understood by reference to the accompanying drawings, wherein

FIG. 1 is an exploded perspective view of the speed controlling twist grip of an electric vehicle according to the present invention,

FIG. 2 is a cross-sectional view of the speed controlling twist grip of an electric vehicle according to the present invention,

FIG. 3 is another cross-sectional view of the speed controlling twist grip of an electric vehicle according to the present invention,

FIG. 4 is a cross-sectional view of the speed controlling twist grip of an electric vehicle under operation according to the present invention; and,

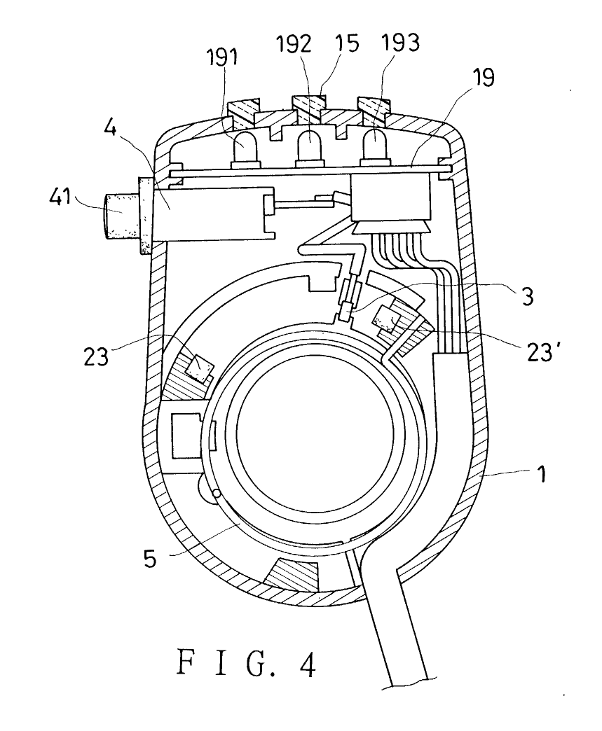

FIG. 5 is a block diagram of working of the speed controlling twist grip of an electric vehicle according to the present invention.

### DETAILED DESCRIPTION OF THE PREFERRED EMBODIMENTS

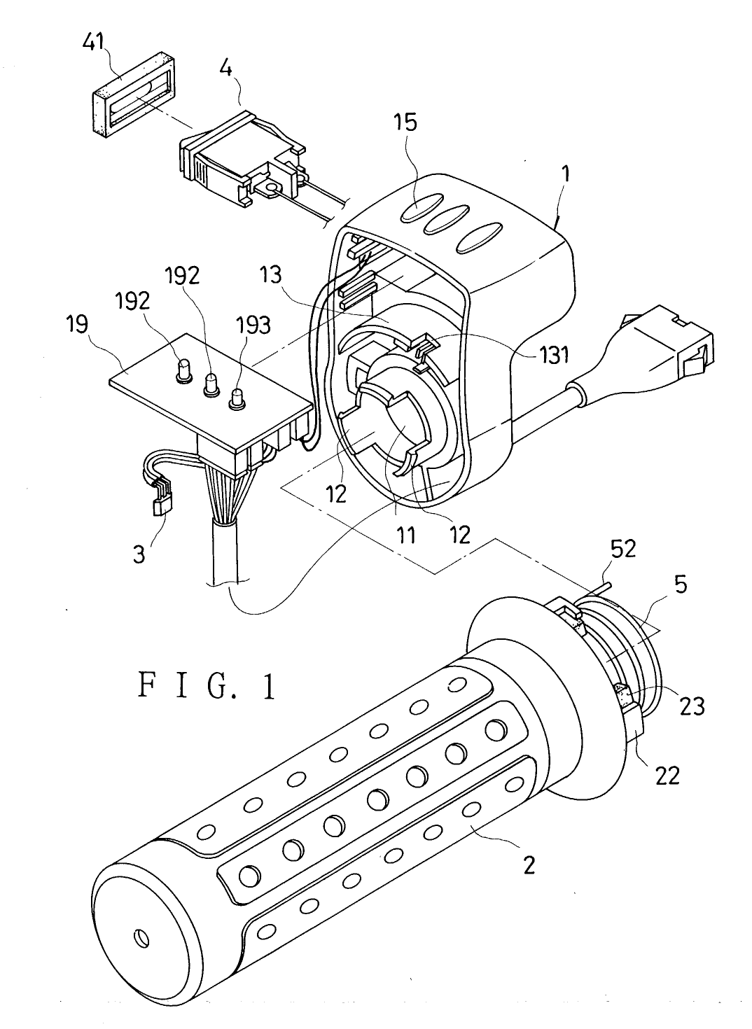

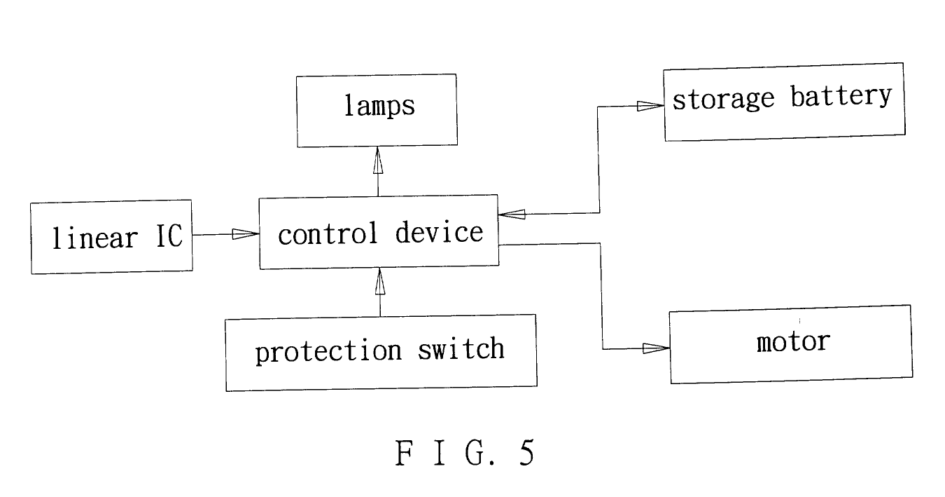

Referring to FIGS. 1, 2, 3, and 5, a speed controlling twist grip assembly of the present invention includes a stationary member 1, a circuit board 19, a turning handle member 2, a linear IC 3, and a control device 6.

The stationary member 1 has a connecting portion, which defines a connecting hole 11 by an annular circular base thereof. The stationary member 1 has several outwards facing hooks 12 spaced out on the annular circular base thereof, and has a separating plate 14, which is formed a distance from an outward side of the annular circular base of the connecting portion. The separating plate 14 is formed with a holding trench 141 extending from one end to the other.

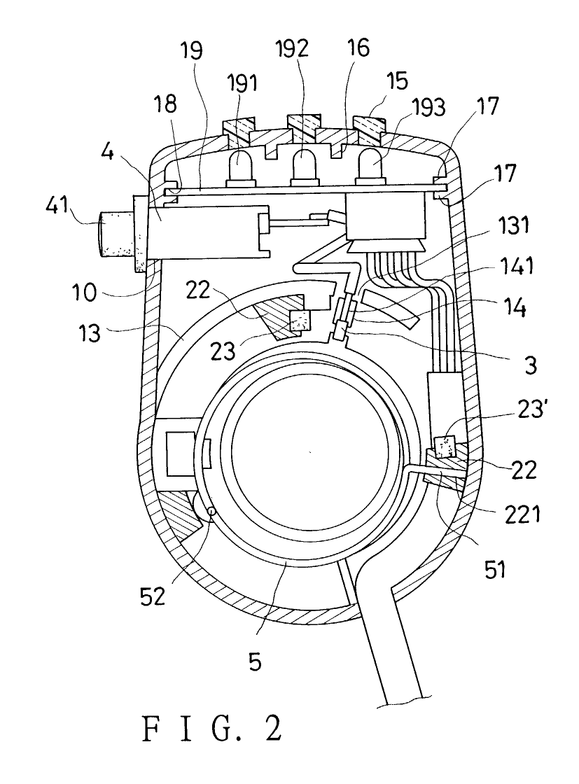

Furthermore, The stationary member 1 has a connecting hole 10 on a lateral side, and three lampshades 15 on an upper side thereof, and a curved wall 13, which is located a distance from the annular base of the connecting portion with a concavely curved side facing the annular base, and which has a gap 131 formed near to the separating plate 14. And, the stationary member 1 has two pairs of holding bars 17 (FIG. 2) projecting from two opposite inner sides thereof to form two opposite holding trenches 18.

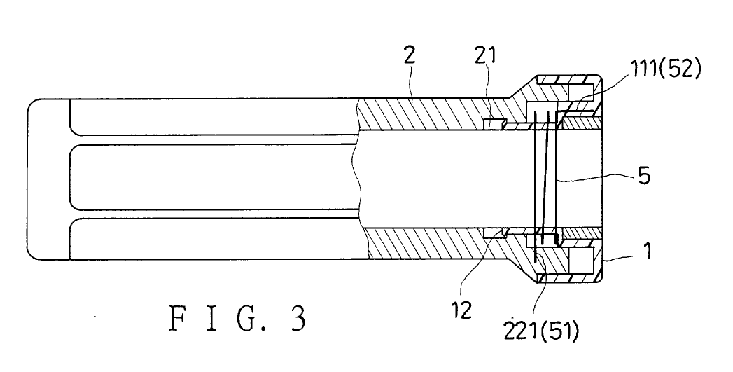

The turning handle member 2 is preferably cylindrical, and has two projections 22, a cylindrical hollow on an inward end thereof and an annular trench 21 around the cylindrical hollow on an inner side of the inward end as shown in FIG. 3. Each of the projections 22 is formed with a holding cavity, and one of the projections 22 has an engaging hole 221 thereon. Furthermore, first and second magnets 23, 23′ are inserted in respective ones of the holding cavities to be joined to the projections 22 such that different magnetic poles of the magnets 23, 23′ face respective ones of two opposite sides of the separating plate 14 of the stationary member 1, and in turn, the magnets 23, 23′ face two opposite sides of the linear IC 3 at different magnetic poles. In other words, if the first magnet 23 faces the linear IC 3 at a north pole thereof the second magnet 23′ will face the linear IC 3 at a south pole thereof and vice versa.

The circuit board 19 is equipped with a first lamp 191, a second lamp 192, and a third lamp 193 thereon. The lamps 191, 192, and 193 can be light emitting diodes.

The linear IC 3 can be a Hall IC, and is electrically connected to the control device 6. The control device 6 is electrically connected to the circuit board 19, a storage battery 8, and a motor 7 so that the first, the second, and the third lamps 191, 192, and 193 can indicate power-insufficient condition, half-full condition, and full condition of the storage battery when emitting light continuously. In addition, the first lamp 191 is used for indicating that there is a fault in the electrical circuit when emitting light intermittently.

The circuit board 19 is joined to the stationary member 1 so that two opposite edges thereof are tightly inserted into the holding trenches 18 of the stationary member 1 and that the lamps 191, 192, and 193 are located under corresponding ones of the lamp shades 15 of the stationary member 1. And, the linear IC 3 is passed through the gap 131 of the curved wall 13, and tightly inserted into the holding trench 141 of the separating plate 14 of the stationary member 1.

The turning handle member 2 is turnably joined to the connecting portion of the stationary member 1 at the inward end thereof by means of mounting the annular trench 21 thereof onto the hooks 12 of the stationary member 1. Furthermore, a protection switch 4 is fitted on the through hole 10 of the stationary member 1, and is electrically connected to the control device 6 so that the motor 7 can be activated only when the protection switch 4 is turned on. The protection switch 4 is provided with a protective shield 41 for preventing rain from leaking into it. And, the protective shield 41 is preferably made of soft materials.

A torsion spring 5 firmly inserted into the engaging holes 221, 111 at connecting ends 51, 52 thereof respectively so that the turning handle member 2 is biased towards an initial non-active position by the torsion spring 5.

Thus, when the protection switch 4 is turned on, the magnets 23, 23′ can move around the annular base of the connecting portion of the stationary member 1 due to rotary movement of the turning handle member 2. In other words, the magnetic field around the linear IC 3 is changed when position of the magnets 23, 23′ relative to the linear IC 3 is adjusted with the user's hand turning the turning handle member 2. Therefore, electric currents passing through the linear IC 3 can be controlled by means of turning the turning handle member 2. And, the control device 6 will control electric power supplied from the storage battery 8 to the motor 7 according to the electric current of the linear IC 3, thus controlling speed of the motor 7. When the turning handle member is not held by a user's hand, and biased towards the initial non-active position by the spring 5, there is no electric power supplied from the storage battery 8 to the motor 7.

From the above description, it can be understood that the speed controlling twist grip assembly of the present invention has desirable features as following:

1. There is no physical contact between the linear IC and the magnets, of which the position relative to the linear IC are changed for controlling electric currents, when the turning twist grip is operated. Therefore, wear can't possibly be caused to the linear IC and the magnets even after long period of use, i.e. the twist grip assembly has relatively long service life as compared with the conventional one as described in the Background.

2. The twist grip assembly has the lamps for indicating various conditions of the storage battery when emitting light continuously, and one of the lamps can indicate a fault in the circuit by emitting light intermittently. Therefore, the twist grip assembly can help people find out the condition of an electric vehicle equipped with it.

What is claim:

1. A magnetic speed controlling twist grip assembly, comprising
a stationary member having a connecting portion, and a separating plate formed at a distance from the connecting portion;
a linear IC fitted to the separating plate of the stationary member; and,
a turning handle member turnably joined to the connecting portion of the stationary member at an inward end thereof; the turning handle member being equipped with first and second magnets at the inward end thereof so that the magnets can move around the connecting portion due to rotary movement of the turning handle member; the first and second magnets being arranged so that different magnetic poles thereof face respective sides of the separating plate of the stationary member for allowing control of electric currents passing through the linear IC by means of turning the turning handle member to adjust position of the magnets relative to the linear IC;
the linear IC being electrically connected to a control device, which is electrically connected to both a storage battery and a motor, so that electric currents of the linear IC can be provided to the control device for the control device to control electric currents supplied from the storage battery to the motor accordingly, thus controlling speed of the motor;
the turning handle member being biased by a torsion spring towards a non-active position where there is no electric current supplied from the storage battery to the motor.

2. The magnetic speed controlling twist grip assembly as claimed in claim 1, wherein the connecting portion of the stationary member has a plurality of hooks spaced out on an annular circular base thereof, and the turning handle member having a cylindrical hollow at the inward end and an annular trench on an inner side of the inward end; the annular trench being fitted onto the hooks of the stationary member for allowing the turning handle member to rotate on the connecting portion of the stationary member.

3. The magnetic speed controlling twist grip assembly as claimed in claim 1, wherein the separating plate the stationary member has a holding trench for allowing the linear IC to be tightly fitted into.

4. The magnetic speed controlling twist grip assembly as claimed in claim 1, wherein the stationary member has a plurality of lamp shades on a top thereof, and a circuit board is disposed in the stationary member, and has lamps fitted thereto and disposed under respective ones of the lamp shades; the lamps being electrically connected to the control device for indicating various conditions of the storage battery and various conditions of combination of those parts that are electrically connected.

5. The magnetic speed controlling twist grip assembly as claimed in claim 4, wherein the stationary member is formed with a plurality of light blocking bars between lower sides of the lamp shades for preventing the lamps from emitting light through those lamp shades that are not corresponding thereof.

6. The magnetic speed controlling twist grip assembly as claimed in claim 4, wherein the stationary member has two pairs of holding bars projecting from two opposite inner sides thereof to form two opposite holding trenches, and the circuit board is joined to the stationary member with two opposite edges being inserted into the holding trenches of the stationary member.

7. The magnetic speed controlling twist grip assembly as claimed in claim 1, wherein the control device is electrically connected to a protection switch, which is fitted on a lateral side of the stationary member, so that the motor can be activated only when the protection switch is turned on.

8. The magnetic speed controlling twist grip assembly as claimed in claim 7, wherein the protection switch is provided with a protective shield for preventing rain from leaking into the protection switch.

9. The magnetic speed controlling twist grip assembly as claimed in claim 8, wherein the protective shield is made of soft materials.

10. The magnetic speed controlling twist grip assembly as claimed in claim 1, wherein the turning handle member has two projections on the inward end thereof which are formed with holding cavities for respective ones of the magnets to be tightly fitted into.

11. The magnetic speed controlling twist grip assembly as claimed in claim 1, wherein both the turning handle member and the stationary member have engaging holes, and the torsion spring is connected to the engaging holes at two ends thereof.

12. The magnetic speed controlling twist grip assembly as claimed in claim 4, wherein the lamps include a first, a second, and a third ones, and the first, the second, and the third lamps are used respectively for indicating power-insufficient condition, half-full condition, and full condition of the storage battery when emitting light continuously.

13. The magnetic speed controlling twist grip assembly as claimed in claim 4, wherein the lamps are light emitting diodes.

14. The magnetic speed controlling twist grip assembly as claimed in claim 12, wherein the lamps are light emitting diodes

15. The magnetic speed controlling twist grip assembly as claimed in claim 1, wherein the linear IC is a Hall IC.

16. The magnetic speed controlling twist grip assembly as claimed in claim 3, wherein the linear IC is a Hall IC.

17. The magnetic speed controlling twist grip assembly as claimed in claim 12, wherein the first lamp is used for indicating a fault in an electrical circuit when emitting light intermittently.
